(19) United States
(12) Patent Application Publication
(10) Pub. No.: US 2013/0325553 A1
(43) Pub. Date: Dec. 5, 2013

(54) APPARATUS, SYSTEM AND METHOD FOR GENERATING AND CONVERTING SALES OPPORTUNITIES

(71) Applicant: Level 3 Communications, LLC, Broomfield, CO (US)

(72) Inventors: Yunas Nadiadi, Superior, CO (US); Rajiv Kumar Singh, Thornton, CO (US); Luke Patrick Phillips, Denver, CO (US); Jeffrey Kendall Storey, Boulder, CO (US); Paul Farnsworth, Niwot, CO (US); Mark William Martinet, Denver, CO (US)

(21) Appl. No.: 13/907,447

(22) Filed: May 31, 2013

Related U.S. Application Data
(60) Provisional application No. 61/654,361, filed on Jun. 1, 2012.

(51) Int. Cl. G06Q 30/02

(52) U.S. Cl. CPC G06Q 30/0205
USPC 705/7.34

(57) ABSTRACT

Aspects of the present disclosure involve apparatus, systems and methods for generating and converting sales opportunities. The apparatus and system may involves an applicatoin and various possible graphical user interfaces (GUI's) running on some form of smart tablet type computing device that accesses geographical information, customer analytic information, and telecommunication infrastructure (or other technical infrastructure) and allows a user to define an optimal travel route between various possible customer based on geographic, customer and infrastructure criteria.

### CROSS-REFERENCE TO RELATED APPLICATION

This application claims priority under 35 U.S.C. §119(e) to provisional patent application 61/654,361 titled “Apparatus, System and Method for Generating and Converting Sales Opportunities” filed on Jun. 1, 2012 which is hereby incorporated by reference herein.

### TECHNICAL FIELD

Aspects of the present disclosure relate to an apparatus, system, and method for assisting sales, marketing and other teams to optimize and increase sales and service performance. More specifically, the present disclosure is directed towards a computer system that assists sales, marketing and other teams in generating and converting sales or other business opportunities, as well as providing services in a more efficient manner and thereby making the sales marketing and other team members more productive, among other advantages.

### BACKGROUND

Identifying and capitalizing on sales opportunities can be a long and complicated process. This is especially true in the modern world where sales associates are often tasked with increasingly complex products and large geographic territories. Sales associates are often required to travel to various customer locations in densely populated areas and at times in unfamiliar cities, states, or countries. Such geographical challenges coupled with the ever-changing nature of customer situations and technology makes identifying customer needs and potential solutions a complicated task. Moreover, there may be many possible customers in a given area, and the sales associate has the task of determining which customers to visit within a limited amount of time. Technology has provided sales associates with systems for keeping track of customer problems, new technologies, and company offered solutions. However, these systems are often only provided on proprietary servers accessible through private intranets. Thus, when traveling or otherwise away from the office, a sales associate may be left without access to the information that would otherwise be available when at a company location or remotely connecting with the private network. This may become an issue when access to such information may be needed in order to, for example, plan visits to prospective clients or customers in unfamiliar geographic locations.

It is with these and other issues in mind that various aspects of the present disclosure were developed.

### SUMMARY

Aspects of the present disclosure involve apparatuses, systems and methods for assisting sales, marketing and other teams in generating and converting sales opportunities. In one particular example, that will be discussed herein to illustrate various inventive concepts set out in the present disclosure, the apparatus and system involve an intelligent assistant application, or “app,” and various possible graphical user interfaces (GUI's) running on some form of smart tablet type computing device (e.g., iPad™), which may have limited memory. The apparatus and system further involve one or more back-end server devices and databases running various applications and storing various types of data accessible over a network with the smart tablet device and particularly the app or apps(s) running thereon. Some aspects of the present disclosure involve an application that includes several computing modules. In one example, the application is designed to optimize routing paths between identified prospective sales targets and/or customers to provide more targeted sales efforts and respond to service requests in a more efficient manner.

The intelligent assistant communicates over a network and interacts with servers running associated applications along with databases of information, such as geographic information system (GIS) data or other mapping and geospatial data, go-to-market intelligence (GTMi) data or other contact and prospect data. The intelligent assistant identifies sales targets, manages and tracks appointments with sales targets, and provides various mechanisms for routing a path between various targets, whether with an existing appointment or not, and within various possible confines, including travel speed, travel distance, time constraints, target value, and various possible sales target opportunities. Moreover, the intelligent assistant allows routing options to influence target appointments. These and other aspects of the present disclosure are discussed in more detail below.

Aspects of the disclosure, more particularly, involve a customer tour optimization system and related method, where the system comprises a computing device including at least one processor and having at least one local memory, the at least one local memory including a plurality of computer executable instructions for execution on the at least one processor, the instructions configured to cause the at least one processor to receive at least one geographic search parameter for a selected geographic area, the at least one geographic search parameter used to determine a geographic boundary for a prospect tour. The processor further configured to receive at least one customer filter parameter, where the at least one customer filter parameter is used to select customers from the selected geographic area based on some attribute of the customer. The processor then accesses a database of customer information associated with the at least one geographic search parameter to identify at least a first customer based on the at least one geographic search parameter and the at least one customer filter parameter. The processor then may determine the prospect tour to the at least one identified customer based on the received at least one geographic search parameter and the at least one customer filter parameter.

These and other features of the apparatus, systems and methods of the present disclosure are described in more detail below.

### BRIEF DESCRIPTION OF THE DRAWINGS

The foregoing and other objects, features, and advantages of the present disclosure set forth herein will be apparent from the following description of particular embodiments of those inventive concepts, as illustrated in the accompanying drawings. It should be noted that the drawings are not necessarily to scale; however, the emphasis instead is being placed on illustrating the principles of the inventive concepts. Also, in the drawings the like reference characters refer to the same parts throughout the different views. The drawings depict only typical embodiments of the present disclosure and, therefore, are not to be considered limiting in scope.

FIG. 1 is diagram of a sample environment in which the aspects of the present disclosure may operate.

FIG. 2 illustrates an example architecture of a mobile sales application that includes program modules that provide some of the functionality in accordance with the present disclosure.

FIG. 3 illustrate an exemplary method for generating an optimal prospect tour in accordance with the present disclosure.

FIG. 4A illustrates a graphical user interface depicting a network map that provides access to some of the functionalities of the intelligent assistant application in accordance with aspects of the present disclosure.

FIG. 4B illustrates a graphical user interface depicting a zoomed-in network map that provides access to some of the functionalities of the intelligent assistant in accordance with aspects of the present disclosure.

FIG. 5A illustrates a graphical user interface depicting an intelligent assistant GUI that allows a user to select a beginning and ending location for a tour, along with an available time and drive distance for the tour, among other functions.

FIGS. 5B-5D illustrate a more detailed view of some of the features provided in an intelligent assistant GUI in accordance with the present disclosure.

FIG. 6 illustrates a prospect tour map generated in response to the selection of some of the features provided by the intelligent assistant application in accordance with the present disclosure.

FIG. 7 illustrates the graphical user interface depicting an intelligent assistant GUI that allows a user to select various options for filtering users for the tour.

FIG. 8 illustrates the graphical user interface depicting some additional prospect filtering options provided by the intelligent assistant application in accordance with the present disclosure.

FIG. 9 illustrates an example optimal prospect tour map generated in response to the selection of some of the prospect filtering options provided by the intelligent assistant application in accordance with aspects of the present disclosure and an intelligent assistant GUI that allows the user to manage identified prospects.

FIG. 10 illustrates some of the prospect information provided to the user by the intelligent assistant application in accordance with some other aspects of the current disclosure.

FIG. 11 illustrates the graphical user interface depicting an intelligent assistant GUI that allows a user to manage prospects excluded from a prospect tour, among other functions.

FIG. 12 is a block diagram illustrating an example of a computing device or computer system which may be used in implementing embodiments of the present disclosure.

### DETAILED DESCRIPTION

Aspects of the present disclosure involve systems, methods, computer program products, and the like that enhance the ability of a mobile sales force, marketing and other team members to generate and convert sales opportunities and respond to customers' needs and requests in a more efficient manner. This includes supplying the sales, marketing and other team members with relevant customer, product, and service information as well as tools for facilitating increased performance. Generally speaking, aspects of the present disclosure involve an application that may run on a mobile device, such as smart phone, laptop type personal computer or tablet style computing device. The application has access to mapping data and customer data and is configured to provide the user with a mechanism to sort and select various possible customers (potential or current) in some geographic area and to provide various possible optimal travel routes amongst the various selected customers based on various criteria that the user may customize. With the tools discussed herein, a sales associate may identify customers based on various possible criteria and then plan and execute an optimal plan for visiting those customers. Using the tool, the sales associate can spend more time with customers, visit more customers, minimize time wasted inefficiently traveling between customers, make the most efficient use of their own time, and realize numerous other possible benefits and advantages.

The apparatus for enhancing mobile sales or response to service requests may include an application running on a computing device. Similarly, the system may involve the application and related information and access to such information used and manipulated by the application, among other things. The application may include various graphical user interfaces (GUI's) connected to or otherwise in communication with one or more data sources located on the computing devices, located in a remote location and accessible by way of a network, as well as a combination of locally and remotely located information. The various GUI's may be configured to facilitate the use of the application's various functions. While interactive and interrelated, each of these functions may be separated into distinct program modules. These various program modules may operate independently from each other, like individual computer programs accessed through a common interface, or they may work cooperatively with each other by sharing user input and information in order to facilitate an effective user experience.

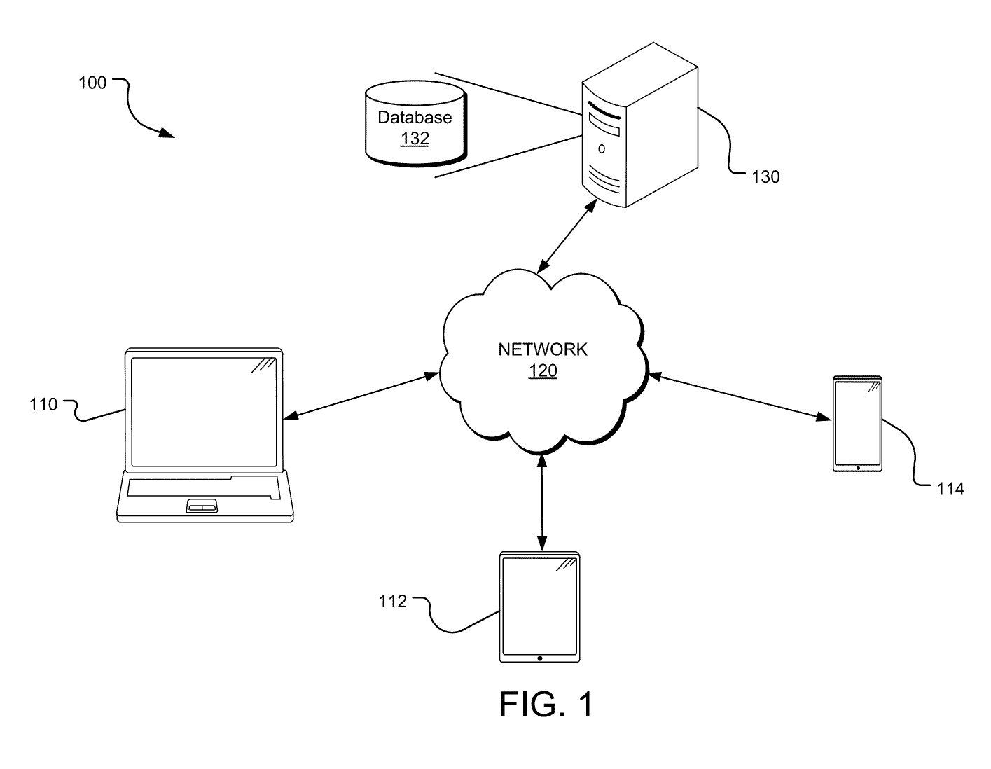

FIG. 1 illustrates a sample computing environment 100 for facilitating increased sales and service performance according to the various concepts discussed herein. In various embodiments, the application may be configured to operate on a general computing device such as a laptop computer 110, a tablet computer 112 (e.g., iPad™, Android™, Surface™), a smart phone 114 (e.g., iPhone®, Android™, Windows Phone™), or any other computing device capable of running a computer application that displays information, receives user input, and connects to a network 120. The network 120 may be any type of computer network including a private intranet, the Internet, or combinations thereof. In some cases, the network 120 may include the Internet along with a virtual private network (VPN) connected to a private network. In many cases, the computing devices 110-114 may be capable of connecting to one or more servers 130 and databases 132 accessible over the network 120. The computing devices 110-114 may connect to the network 120 in any manner, including using an 802.11 wireless network protocol and various cellular network protocols such as GSM, CDMA, HSPA+ and LTE, among others. The computing devices 110-114 may also be capable of running various applications and storing various types of data accessible with the computing device, particularly the application or applications running on the device or otherwise accessible from device. It is also possible that the computing devices may load relevant information while connected to the network 120 and locally store that information so that various functionalities discussed herein are available when the device is not actively connected to the network 120.

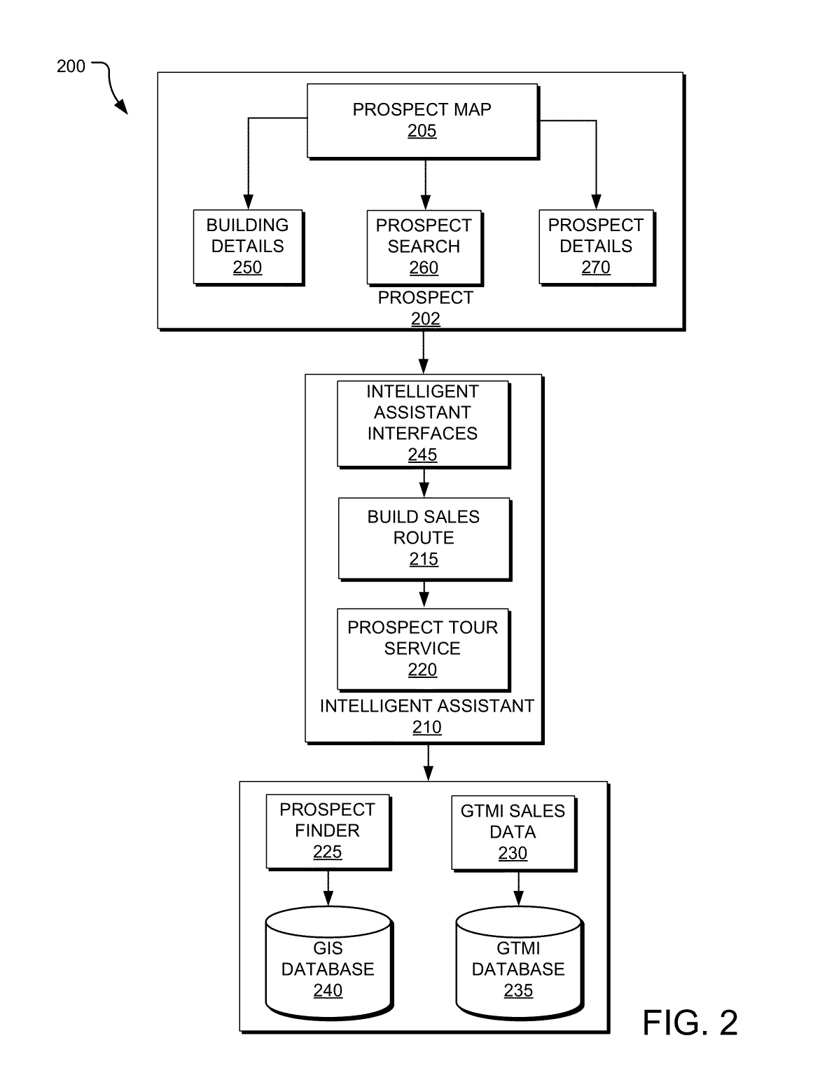

FIG. 2 is an application overview diagram 200 that includes various possible computing modules involved in the provision of the various functionalities discussed herein. In particular, an intelligent assistant application/module 210 may include and/or interact with such modules as a build sales route module 215, a prospect tour service module 220, a prospect finder module 225 and a GTMi sales data module 230. In general, the intelligent assistant 210 module captures user constraints for a prospect tour and displays an optimal path and sequence for visiting prospects determined by the build sales route module 215.

In the example shown, the build sales route module 215 uses information provided by the prospect tour services module 220 that determines the shortest paths between the prospects for the user's required drive times and distances, with the prospects being identified by the prospect finder module 225. In particular, the prospect finder module 225 identifies a subset of the customers/buildings (prospects) from the available customers/buildings located within the scope of a geographic search area determined by the GTMi sales module 230, which scope is based on a user's filter criteria on a prospect value. Stated differently, a user, through various GUI's, defines various geographic attributes of a tour and also various attributes of prospects to be visited on the tour, and the intelligent assistant identifies applicable prospects meeting the attributes and generates an optimal path for visiting the identified prospects. As shown, the prospect finder module 225 and the GTMi sales module 230 may further interact with one or more databases, such as, for example, a go-to-market intelligence (GTMi) 235 database and a geographic information system database (GIS) 240 in order to extract information need to identify and sort customers and to build sales routes, among other things, in accordance with the aspects of the current disclosure.

Although as discussed above the intelligent assistant application may be a stand alone application, in one specific implementation shown in FIG. 2, the intelligent assistant application may be integrated into or form a part of a prospect module 202 described in more detail in a co-pending application Ser. No. 13/733,573 titled “Method and Apparatus for Generating and Converting Sales Opportunities,” which is incorporated herein by reference. From a general perspective, the prospect module 202 provides an interactive map that may include technical infrastructure of some kind, such as optical networks and telecommunication network information, as well as customer or prospective customer information, and the relationship between the same. So, for example, a user may zoom into some specific area, like lower Manhattan and view all possible customers in the area and the relationship to some form of technical infrastructure. The intelligent assistant functionalities discussed herein further leverage the prospect information to generate an optimal tour route between some numbers of customers in some area, and may generate that route based on various possible criteria related to the time available for travel, the distance to be traveled, and the nature of the customer or other issues related to the customer.

Returning to FIG. 2, the various modules may also provide functions related to the technology discussed in the '573 application and are thus not discussed in detail herein. Integrating the intelligent assistant module functionality with the prospect module 202 functionalities not only simplifies the user experience, as a single interface may be used to access various functionality of the overall system but also provides the intelligent assistant with access to the various functions implemented, accessible or otherwise associated with the broader prospect module 202. In particular, the intelligent assistant 210 may be provided with access to such functionalities of the prospect module 202 as the prospect search 260 that allows a user to search for a particular customer in a given geographic area, prospect details 270 that access a customer (prospect) database to obtain and display information on an identified customer prospect (e.g., information such as contact information, internal rate of return, number of employees, current services provided, etc.), and building details 250 that provide information on buildings identified within a geographic area (e.g., building information such as whether the building is on-net, whether there are current customers within the building, and prospect information about tenants within the building). In general, the prospect module 202 addresses issues involved with a geographically dispersed and complex technical infrastructure that are relevant to various services, products, and opportunities associated with revenue and relevant to the mission of the sales person. Moreover, the prospect module 202 associates customer opportunities with the geographically dispersed technical infrastructure.

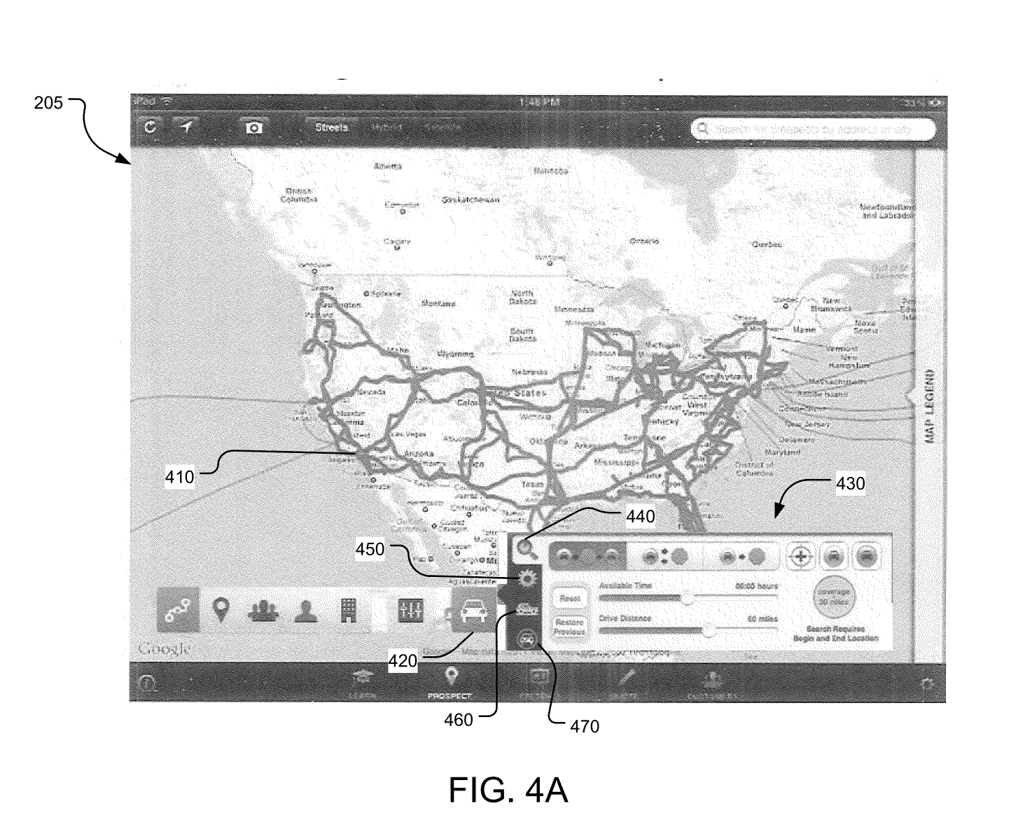

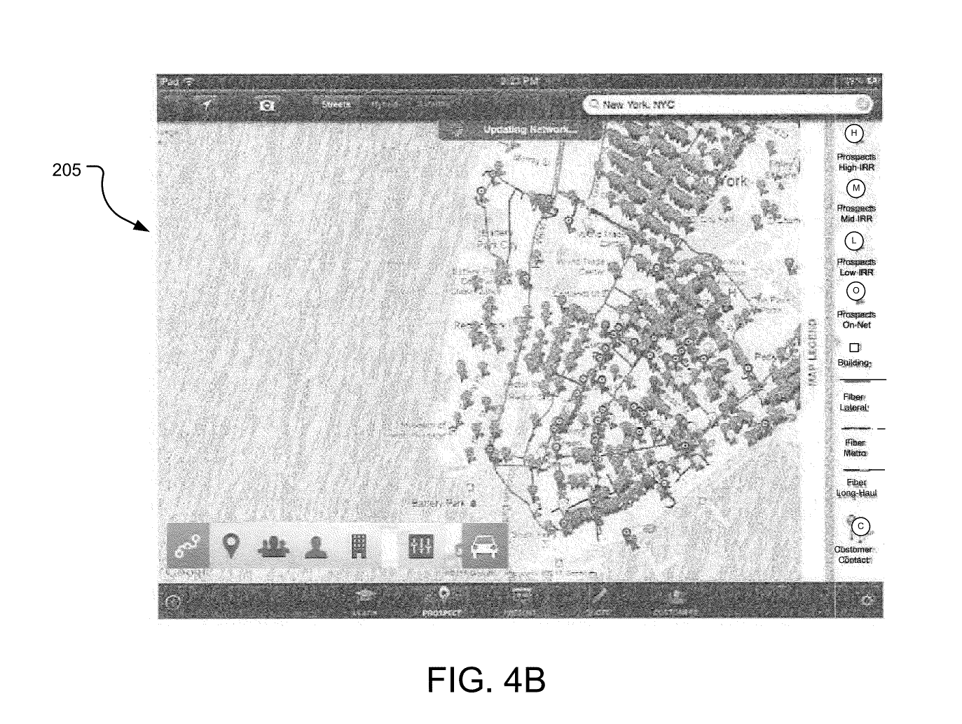

When a user first accesses the prospect module 202, such as by selecting an icon on a touchscreen of a tablet, the prospect module may display a geographic map 205 such as shown in FIG. 4A. Further, the map 205 may display some form of technical infrastructure in the geographic area. In the example of FIG. 4A, a telecommunications network 410 is shown throughout the continental United States. The telecommunications network involves high speed data networks, including optical fiber and networking equipment such as gateways, routers and the like; including equipment that facilitates data connections to the network. Other applicable technical infrastructure includes, but is not limited to, cable networks, cellular networks, water distribution systems, natural gas pipelines and distribution systems, electric power distribution systems, among others.

The geographic data and technical infrastructure data may involve large amounts of data, well in excess of a terabyte. Thus, displaying, mapping and otherwise providing a comprehensive understanding of the geographic data and the technical infrastructure data requires more memory than may be currently available in tablet devices or other smart mobile devices, or even some lap-top computers. Since aspects of the present disclosure may be used or particularly suited for mobile use, the prospect module 202 and intelligent assistant functions, besides presenting and allowing manipulation of the geographic and technical infrastructure information, manages memory in a unique way. Additionally, the prospect module 202 loads and provides target customer data in a unique way relevant to the associated technical infrastructure allowing the sales person to quickly and efficiently identify customer targets relative to the technical infrastructure.

More particularly, in one possible example implementation, the prospect module 202 first presents a low resolution view of some significant geographical representation of the extent of the technical infrastructure. In the present example shown in FIG. 4A, the prospect module 202 presents the full geographic scope and high level layout of a long haul fiber network that spans the United States. The system includes some default graphical representation of the technical infrastructure but also allows the user to select additional related infrastructure, such as lateral and metro networks besides the long haul network.

The initial infrastructure and/or geographic data are locally stored and/or cached. As a user zooms into some area, the prospect module 202 initially displays the zoomed area using cached infrastructure and geographic data. In the background, the prospect module 202 accesses a remote database, such as the GIS database 240 and loads higher resolution data for the zoomed area. When sufficient data is cached, the prospect module 202 updates the display with the higher resolution geographic and/or technical infrastructure data. The tool is designed for a regional, national or global sales force, and thus the tool is designed to address the needs of sales people dispersed throughout the geographic area.

When a sales person has identified a target geographic area, the prospect module 202 may overlay the geographic and infrastructure display with additional customer related data, such as go to market intelligence (GTMi) data accessible from the GTMi database 235 that includes sophisticated customer and prospect financial data. The financial data may be used to generate internal rate or return (IRR) projections as well as monthly recurring revenue (MRR) projections for the customers. The system may display target customers by internal rate of return IRR or MRR and may take into account the proximity of the prospect to the target infrastructure as well as other factors impacting the ability to provide services to the prospect using the technical infrastructure, and may include graphical cues concerning the same. The data may also include graphical cues relevant to other information associated with the prospects, including ranked IRR projections (e.g., high, medium, low), customer contact information (e.g., available or not available), and proximity to technical infrastructure (e.g. on net (no significant additional infrastructure necessary to connect prospect with network)). The prospect module 202 allows the user to zoom to various levels of detail, allows the user to filter the various display parameters (e.g., top 100 prospects, top 10 prospects, prospects with contact information, etc.).

In FIG. 4B, the user has zoomed into lower Manhattan, and the prospect module 202 has used GTMi data to initially display numerous existing or target customers in the area. The map 205 illustrates each possible prospect with some form of graphical icon that correlates to an attribute or attributes of the prospects shown. The map also includes different graphical representations of the various technical infrastructures, such as lateral fiber, metro fiber, and long-haul fiber, within the area. As shown, the user can visualize all possible prospects in the area. Moreover, through various possible prospect functionalities, the user can filter the prospects to only show those prospects with specified attributes.

The graphical geographic and infrastructure representations are also access points to additional rich content. For example, prospect cues, when selected, display information about the prospect, including street address, specific IRR projections, contact information, and possibly others. In the case of an on-net building, for example, the prospect module 202 may also display building information including tenant information, aggregate IRR projections, tenant specific IRR projections, existing customers (for which additional services might be sold), and other information.

The prospect module 202 may also interact with other systems. For example, a sales person may identify a particular tenant as a “lead” and update that information to another site, module or application, such as Salesforce.com, and then launch the application(s) associated at the third party site. In the case of a third party web based service, the tablet or other device running the prospect module may automatically establish a network connection, launch a browser and connect with the site. In one example, some or all available prospect data may automatically be loaded from the prospect module 202 to the site. The prospect module 202 further allows the user to email prospect details to other sales team members, bookmark prospects, interact with other modules and application and exchange data therewith, and may link information from the prospect module 202 to other modules.

The prospect module 202 may also provide access to the intelligent assistant or traveling salesmen module 210 and otherwise provide the user with access to functionality that will help the user efficiently plan a route amongst various possible prospects. It should be noted that the terms prospects and customers are often used interchangeably herein. Moreover, each term may refer to a current customer or may refer to a potential or target customer, where the potential customer may involve new services or products for an existing customer or a completely new customer. Referring to FIG. 4A, by selecting an icon 420, the user is provided with an intelligent assistant GUI 430. Here, the intelligent assistant GUI 430 is accessed from the prospect map 205. However, other forms of access are possible, and the use and navigation by way of the prospect tool is but one example.

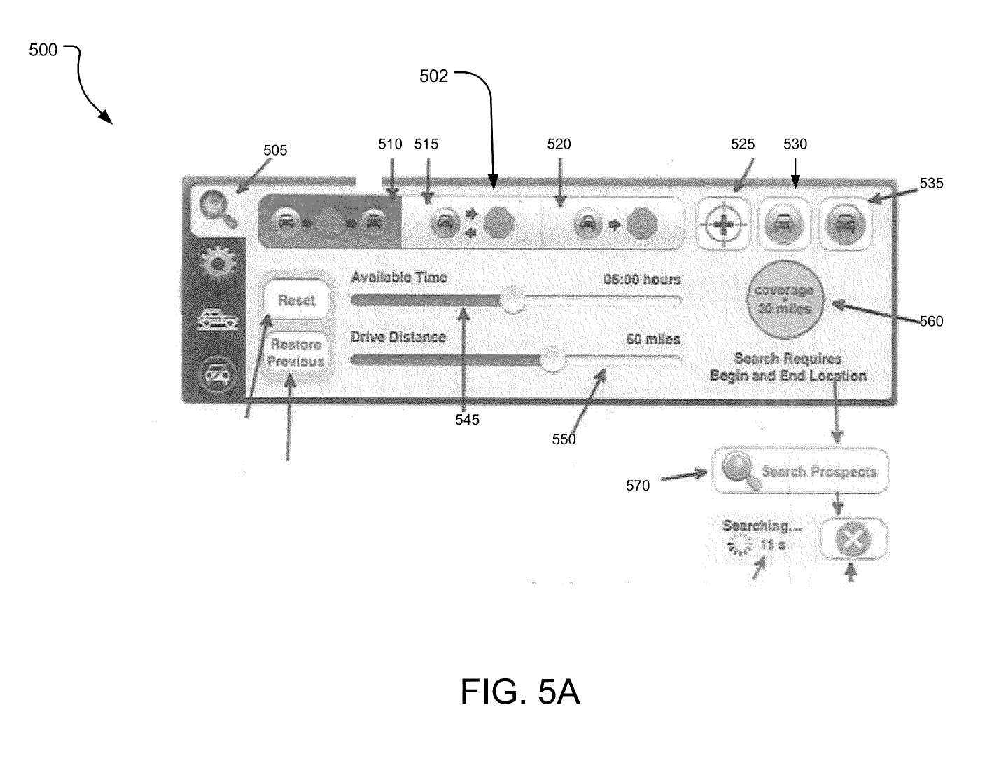

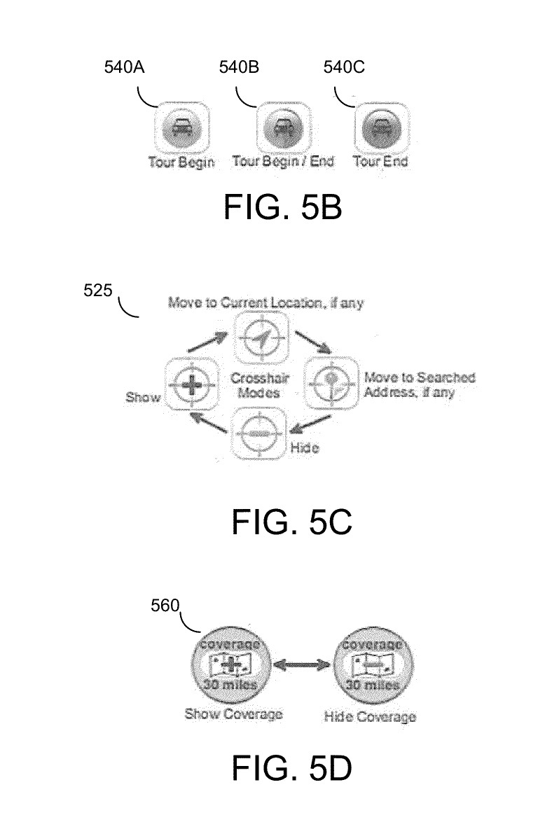

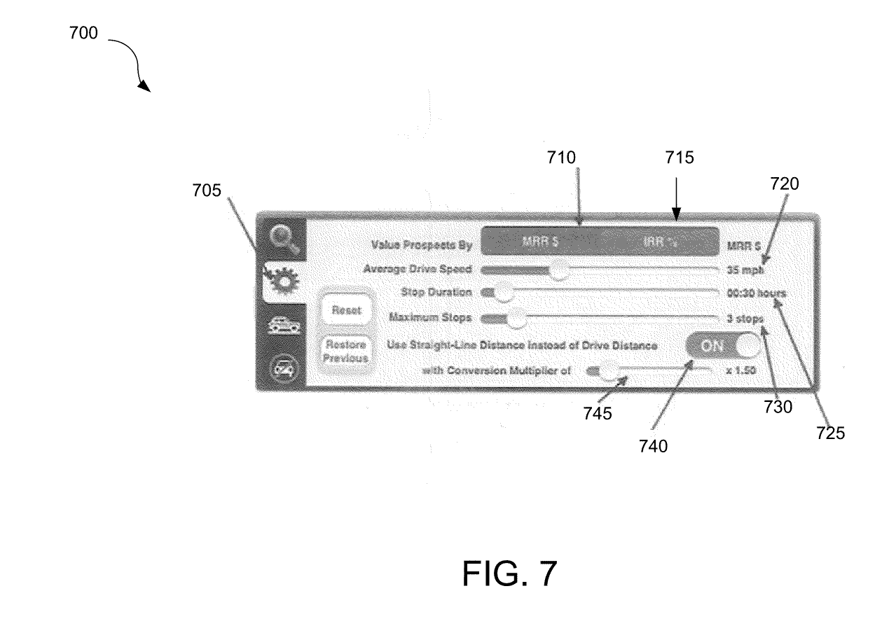

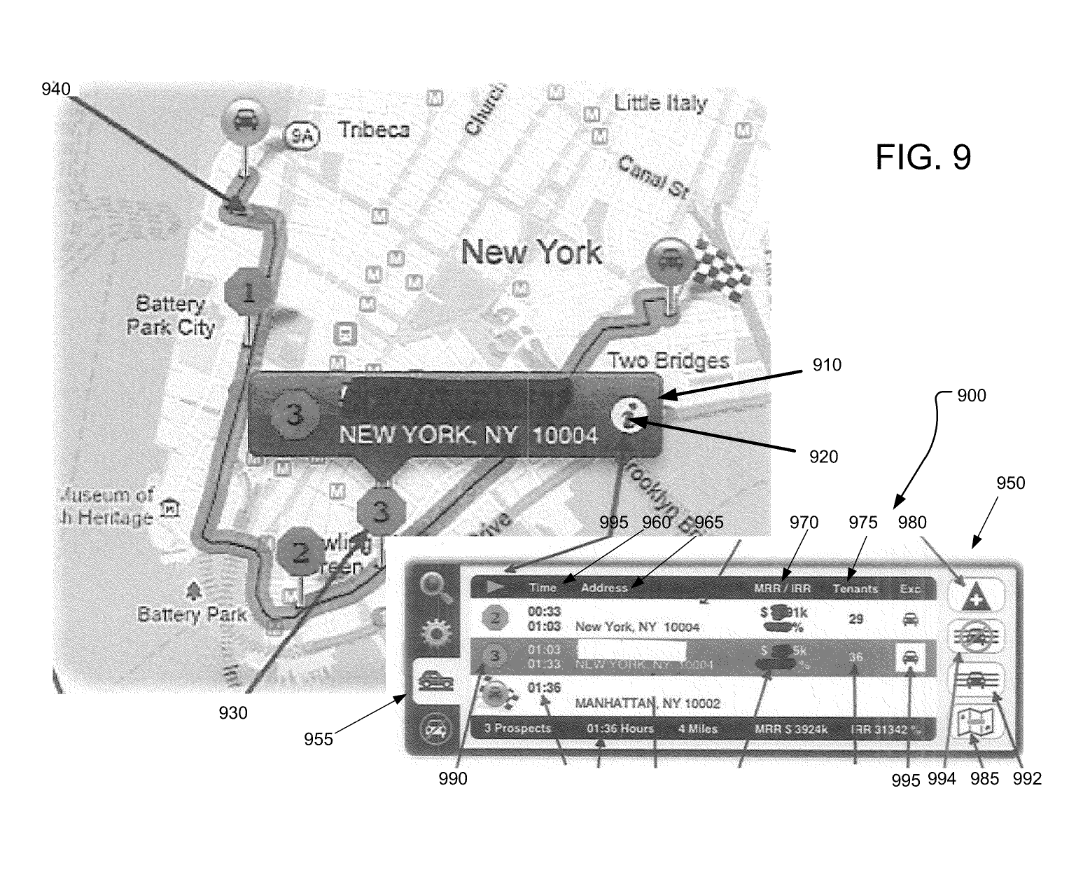

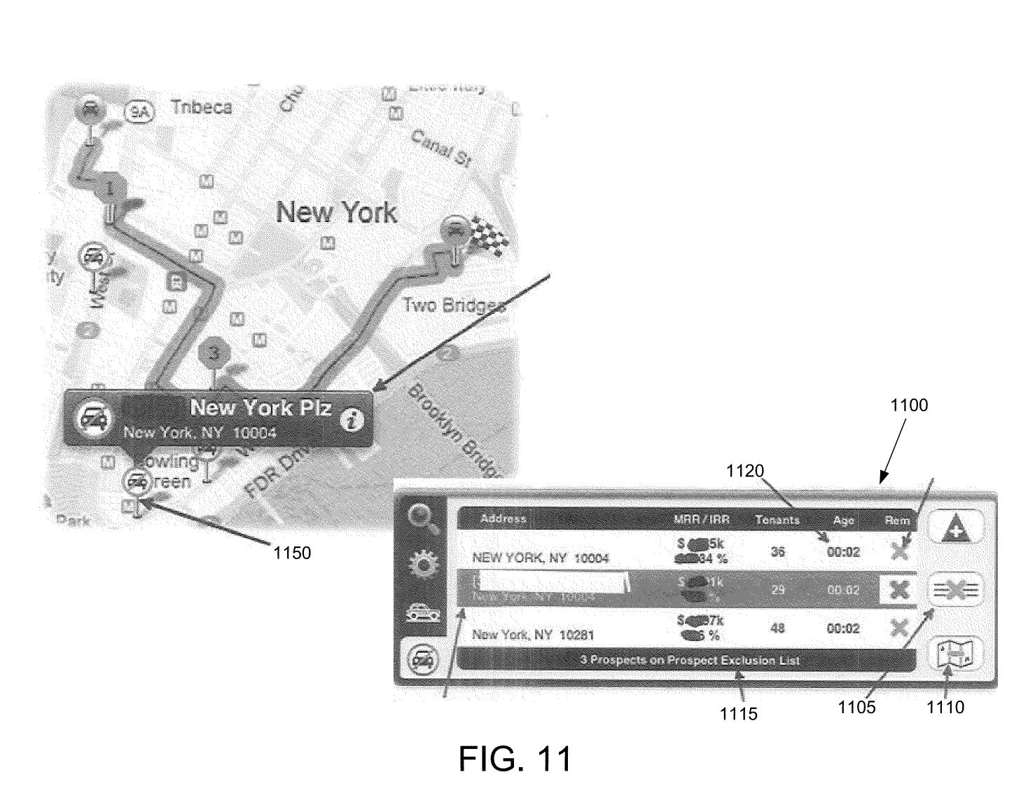

The intelligent assistant GUI 430 provides the user with a number of different options that allow the user to define and customize a prospect tour. In one specific example, the intelligent assistant 210 provides the user with an option to generally define prospect search area, to customize a prospect tour, to visualize and manage prospect tour and/or prospects included in the prospect tour. To access any of these functionalities, the user may select one of the provided function tabs 440, 450, 460 and 470 respectively. Thus, for example, the intelligent assistant 210 may provide a prospect search GUI 500 (FIG. 5A) through which the user may provide information relevant to boundaries for the tour. The intelligent assistant 210 may also provide a configuration GUI 700 (FIG. 7) through which the user can enter criteria for selecting prospects for the tour. The user may visualize and manage tour and/or prospects included in the tour through either prospect tour GUI 900 (FIG. 9) or excluded prospect GUI 1100 (FIG. 11). The intelligent assistant 210 may further include various interfaces 245 through which a user or other modules or services may interact with the intelligent assistant 210.

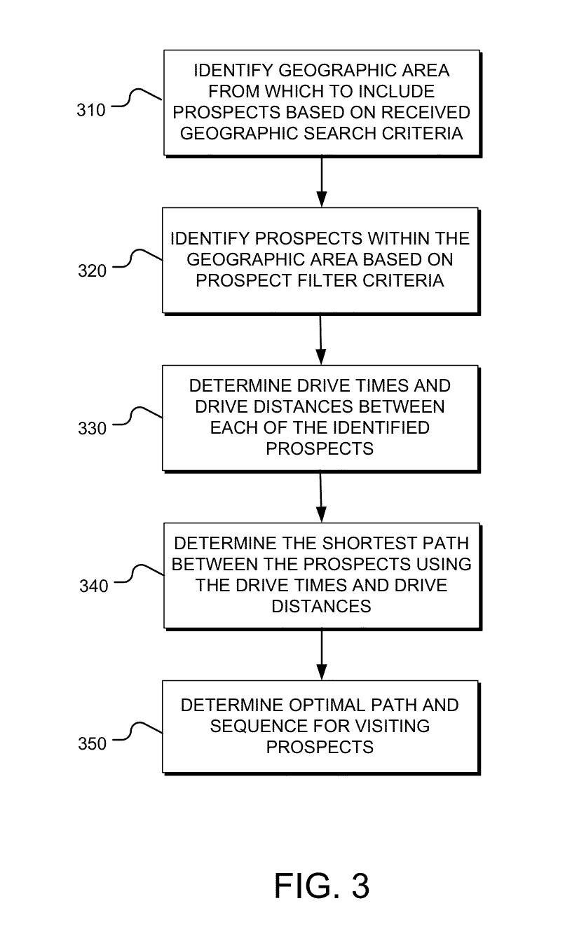

Now, in order to discuss the use of the system as well as the methods for generating a prospect tour, reference will be made to FIG. 3, which illustrates one possible method of generating a prospect tour, as well as various interactive user interfaces and displays by which a user defines a tour and is presented with the tour along with information about the prospect that are subjects of the tour. Generally speaking, a salesperson uses the intelligent assistant to generate a tour route between prospects in order to plan visits with each prospect, which may be referred to herein as a “tour.” The prospects to be visited can be constrained by a number of means including the start location for the tour, the time available for the tour, the maximum driving distance of the tour, and/or the desired end location for the tour, among other possible factors. Additionally, the prospect tour may account for financial measurements or other data associated with the customer or prospects in a given region. Thus, besides establishing various constraints on the tour, such as starting location and time, the user may also establish criteria of the type of prospects that will be visited on the tour. For example, the user may seek to limit the tour to only existing customer that have an open trouble ticket or existing customers with some value of IRR or MRR. The user might also limit the tour to potential customers that are in a building that is connected to the fiber network (on-net). In general, the methodology set out in FIG. 3 uses a number of parameters that together help generate an optimal prospect tour route for a selected geographic location.

To create a prospect tour, the user first identifies or otherwise inputs various parameters or search criteria that will establish bounds for the tour (operation 310). Referring to FIG. 5A, in one specific example, the user is presented with a prospect search GUI 500 where the user may define the search criteria that help to define a geographic area from which prospects in the tour may be included. FIG. 5A shows an example of the prospect search GUI 500 along with descriptive text of the functionality of various aspects of the GUI that provide a user with the ability to tailor various input parameters to generate an optimal prospect tour of a particular geographic area. As shown in FIG. 4A, the search GUI may be displayed on the prospect map 205 in response to the selection of the intelligent assistant icon 420. Regardless of the mechanism by which the user accesses the search GUI, the search GUI includes various mechanisms by which the beginning and/or ending points, available time or drive distance of a prospect tour may be defined.

The search GUI 500 provides the user with search mode options 502 that allow the user to define prospect tours based on the user's specific needs. Thus, for example, the search GUI provides three options for the user to define the tour based on some combination of the starting and/or ending location of the tour. Namely, a first option or “tour begin and tour end” option 510 allows the user to define the beginning and the ending locations of a prospect tour. In this example, the user can identify beginning and ending locations by entering address information into, for example, a provided address box, selecting address information from existing contact information, and/or using a “crosshair” function to select a start and/or end location on the map. Alternatively, if the user is physically at the start location, the user may use location services, and through GPS, GIS, and/or other mapping mechanisms, the intelligent assistant may map the user's current location, and use the current location as a starting location for the tour.

To enter or select address information from existing contact information for the tour starting location, the user may first select the tour begin button 530 from a number of location buttons 525-535 provided in the search GUI. Similarly, to enter or select address information for the tour ending location the user may select the tour end button 535 from the provided location buttons. In those instances when specific information about the tour beginning and/or ending locations is unknown, a crosshair function 525 may be used to identify the beginning and/or ending locations. As shown in FIG. 5C, to use the crosshair function, the user may select from among different crosshair that become available by tapping the provided crosshair button 525. The crosshair function may be linked to database information such that building, address, and/or tenant information is displayed when the crosshair is positioned over a particular location. Moreover, the user may select some aspect of the displayed information and obtain additional information concerning the location, tenant, and the like.

The crosshair functions in three modes or may be hidden. First, the user may position the map under the crosshair, such as by touching the screen and moving the map, and may select the tour begin or end location to coincide with the position of the crosshair on the map. The user may also cause the crosshair to move to the user current location if GPS services are active. Here, the user may cause the crosshair to select the user's actual current location as the tour start or end location by selecting the proper icon 540A, 540B or 540C. Finally, if the user enters or selects a starting or ending address, the crosshair function may be positioned at the address, and used to select that location as a tour beginning and/or tour ending location.

In one example, the intelligent assistant interacts with and otherwise communicates with a GTMi database or other database of contact and prospect information in order to obtain prospect information. GTMi is a database including information concerning various prospects for the service or product relevant to the sales forces employing the intelligent assistant. For example, in the case of telecommunications, the GTMi database may include the following information: building location, tenant list, contact information for the tenants, date of last contact with the customer, open tickets or other service related information such as trouble ticket counts, number of employees per tenant, whether the building and/or tenant is on-net or off-net, whether a tenant is a customer and the existing services being provided to the customer, measurements of rate of return or other financial metrics of the customer or projections of rate of return or other financial metrics if not a current customer, capital investments in infrastructure to service new customers along with other relevant information. The GTMi database may also obtain information or the intelligent assistant may interact with other databases or systems to provide information concerning potential customer contacts, such as those provided by Salesforce.com.

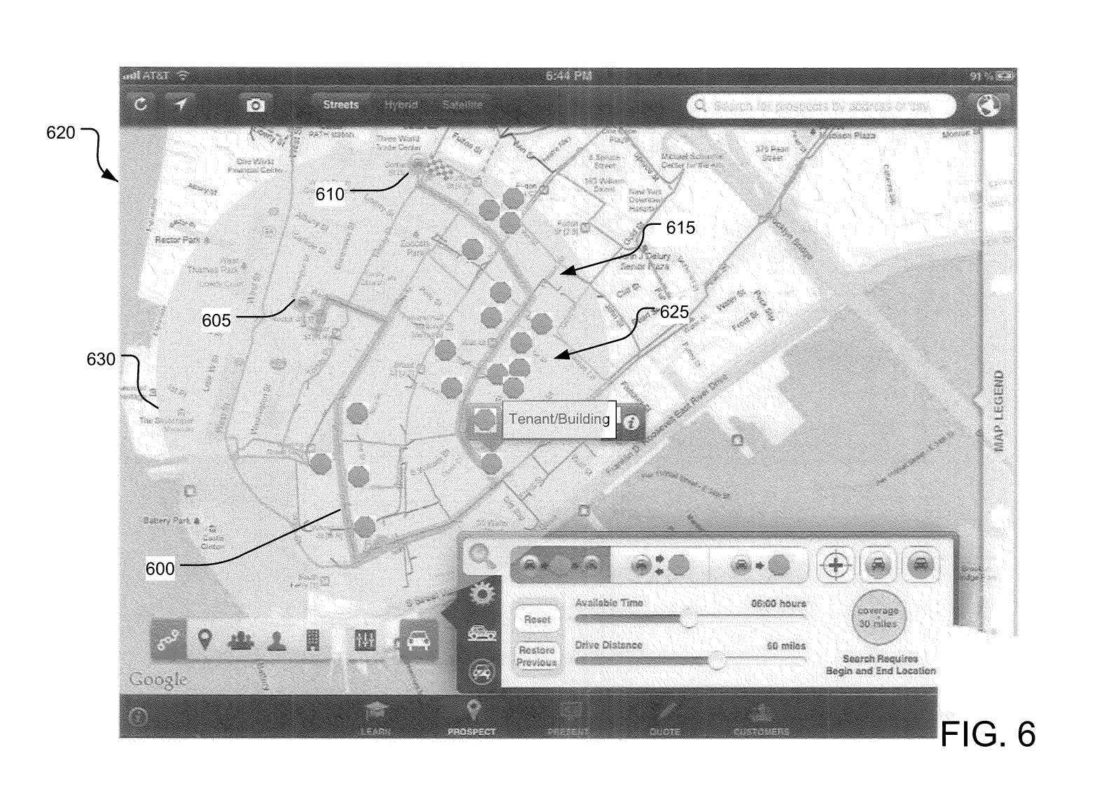

Regardless of the method used to enter the beginning and ending location information, once provided, the system places appropriate tour beginning or ending location pins 540A, 540B or 540C (FIG. 5B) at the specified endpoints of the tour. FIG. 6 illustrates one example of a tour 600 with a beginning pin 605 and an ending pin 610 at the respective start and end of the tour 600. FIG. 6 also shows nineteen prospects 615 along the tour. The tour here is displayed on a map 620, again in the lower Manhattan area. Once displayed on the map 620, the location pins if or otherwise selected, provide the address or other information (e.g. prospect information) associated with the pin location.

Referring again to FIG. 5A, besides defining both a beginning and an ending location through the function 510, the search GUI 500 also allows a user to begin and end a prospect tour at the same location or specify only a start location for the tour. These two tour definition modes are available to the user through the selection of either a “same begin/end location” button 515 or a “begin location only” button 520.

In addition to allowing the user to specify starting and/or ending locations for a prospect tour, the system also allows the user to define the available time for the tour. In one specific implementation, the user may select the maximum time allowed for the tour by using an available time sliding bar 545. So, for example, if the user is traveling to a location and has a limited amount of time to visit various prospects, the user can define the time available. The available time option may also be used to keep track of the tour time and decreases as the salesman travels to the prospects' location and also by the stops made at the prospect location. In the instance when the tour ends at the last prospect visited, the available time will be inclusive of the engagement at the last prospect.

The total drive distance for the tour, which specifies the upper limit of the drive distance the tour will encompass, may be specified by using a drive distance sliding bar 550. This feature allows the user to define the maximum distance that will be traveled on the tour. So, for example, the drive distance function would allow the user to limit the travel distance for a congested metropolitan area to account for traffic and a dense population of customers and prospects whereas the user may define a larger travel distance for a suburban area with less congestion and geographically dispersed customers and prospects.

The starting location, ending location, available time and drive distance functions may alone or in combination be used to determine a geographic envelope where prospects will be searched to be included in the tour. Once some or all of the search inputs are entered by the user into the search GUI, a prospect finder module may compute a geographic area or geographic envelop from which prospects for the prospect tour may be selected (operation 320). In particular, the prospect finder module may rely on the information stored in any number of external databases, including prospect database, geographic database and/or an infrastructure database to determine the prospect geographic envelope. In one specific implementation, the geographic envelope, which identifies the prospect search area based on the entered inputs, may be visualized on the map with a shaded transparent overlay. In the example shown in FIG. 6, the transparent overlay is in the form of a circle with the geographic area encompassed by the circle being the area in which prospects will be searched to be included in the tour. By changing various tour parameters, the user may alter and view the changed coverage area with the transparent overlay. Thus, if the user seeks to cover more or less prospects and geographic area, then the user may alter the tour parameters until the coverage area is appropriate. More specifically, as shown in FIG. 5D, the coverage tool may be toggled between show and hide modes. When selected, the coverage tool provides a translucent overlay 630 on the map (see FIG. 6) within the indicated coverage radius from the location pins in order to assist the user in identifying customers and/or prospects for the tour. In other words the coverage tool enables the user to visualize the area from which a tour of prospects may be generated. Further, the system may limit the identification of prospects, in later operations discussed herein, to those prospects within the coverage area. Should the user wish to encompass a larger or smaller area, the user may adjust the start location, end location, available time and/or drive distance in order to adjust the coverage area.

Returning to FIG. 6, a number of identified prospects 625 are shown within the computed geographic envelope 630. In particular, the prospects shown on the map were identified by performing a query in appropriate databases in response to the inputs provided by the user as discussed above. In one specific implementation, the query was performed by the prospect finder module 225 and the GTMi sales data module 230 once a search prospect button 570 located in the search GUI 500 was selected by the user. Here, the prospects are part of a defined tour. Prior to inclusion in the tour, additional prospects with the envelope 630 would also be illustrated.

Referring again to FIG. 3, in order to generate a more targeted prospect tour route, the user may also limit or customize the list of prospects that are to be included in the tour by using a number of available prospect filters (operation 320). In particular, the user may filter prospects in the previously computed geographic area by providing or selecting prospect filters available through additional GUIs provided by the intelligent assistant. The system may then perform additional queries in any number of available databases, including database of prospects, a geographic database, and an infrastructure database to generate a list of prospects within the computed geographic envelope based on the defined prospect filters.

Shown in FIG. 7 is a configuration GUI 700 that provides the user with additional options for selecting or filtering prospects for the prospect tour. The GUI 700 provides the user with the ability to more specifically define the tour through geographic criteria (operation 310) as well as to filter prospects within the envelope. Before discussing the filtering functions, the geographic functions of the GUI 700 will be described. More specifically, the GUI 700 allows the user to define the average drive speed for the tour, the duration for each stop on the tour and the maximum number of stops on the tour. In one particular implementation, the configuration GUI 700 is displayed in response to the selection of the configuration tab 705 provided by the intelligent assistant. Here, the user can use slider bars to define the average drive speed 720 in the area of the tour, the stop duration 725, and the maximum number of customer and/or prospect stops to identify on the prospect tour 730. In particular, the user may specify the average drive speed for the tour based, for example, on his previous driving experience in the area by sliding the provided slider along the average drive speed bar. Furthermore, the stop duration option 725 provides the user with an ability to define the length of a stop at each prospect location. The stop duration option 725 may provide the user with the ability to specify a minimum duration for each stop or the ability to specify stop duration on a per prospect basis. In one specific implementation, the stop duration on the per prospect basis may be defined as being larger than minimum duration for each stop and if not specified by the user, the per stop duration may default to the minimum stop duration.

In addition, the user can customize the tour and in particular the type of information determined and provided by the intelligent assistant by selecting some of the additional options provided in the configuration GUI 700. Thus, for example, the user can customize the tour to use straight-line distance calculations 740 between stops instead of drive distance. The straight line distance may be selected, for example, when speed over accuracy is desirable. Namely, the straight-line distance 740 may be selected when the user is mainly interested in gaining a general knowledge of the distance between, for example, user's current location and the various locations of the identified prospects rather than the being provided with actual driving distance to the various prospect locations. Additionally, a conversion multiplier 745 that generates information on the drive distances as a percentage of the straight-line distance may be specified by the user, for example, for an urban area where there is no straight path between locations. The system may also use road information and mapping sequences to determine the actual distances between stops.

Referring now to the prospect filtering functionality, the configuration GUI 700 also allows the user to filter or otherwise customize the prospect tour based on some valuation of the customers or targets within the area being searched for the tour. Thus, the prospects displayed within the coverage area will be filtered by the criteria selected such that only those prospects meeting the filtering criteria will be displayed and available for inclusion in the tour. In this example, the user can determine and/or filter prospects using prospect parameters that are based on any number of prospect attributes associated with each prospect. For example, prospects can be identified using such prospect attributes as monthly recurring revenue (MRR) or Internal Rate of Return (IRR) data. As shown in FIG. 7, user can filter prospects base on either MRR or IRR data by selecting either the MRR $ button 710 or the IRR % button 715. In one specific implementation, prospect parameters may be used to identify and sequence prospects based on geographical location and a ranked value. More specifically, prospects may be ranked using a prospect value which is a function that maps prospect's attributes, such as IRR or MRR, to a number. In one possible context, prospects may be characterized based on the projected value, with higher value prospects ranked ahead of lower value prospects. Hence, the user can, for example, limit the search to the highest value targets. According to one specific implementation, the prospect value may be additive. Namely, for a selected set of prospects, the prospect value may be a combined value that is obtained by summing up prospect values for each prospect in the set. The cumulative prospect value may be used, for example, to define a prospect route for a group of prospects. In other words, when a cumulative prospect value for a selected group of prospect is reached those prospects would be included in the tour. Additionally, the user may also filter the search based on other criteria such as the trouble tickets (visiting a customer that has had service problems), contact timing (visiting a customer that has not had any contact for some time), and/or other criteria. The system includes numerous mechanisms to focus and optimize a tour for a given user.

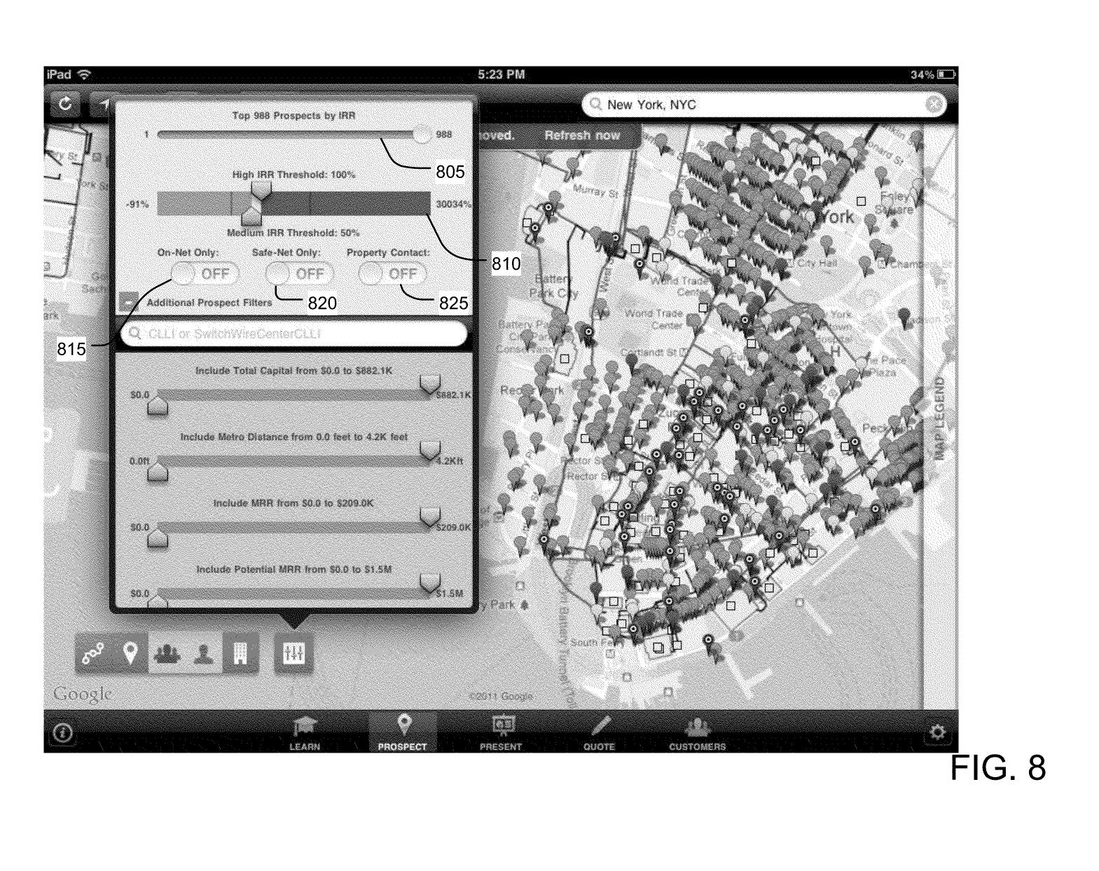

FIG. 8 illustrates one mechanism by which a user can filter prospects based on IRR data and/or MRR data. In one specific implementation, a threshold bar 810 may be used to provide a user with the ability to select a range of IRR by which to filter prospects. In this example, the slider includes two user settable points to set the lower and higher bound for IRR filtering. Further, the slider is color coded to denote a low IRR threshold, a high IRR threshold, and a range of medium IRR values between the low and high ranges. The intelligent assistant may use the selected prospect parameters to either narrow or expand the number of available prospects for the tour, from the total number of available prospects in a given geographic area as indicated by the prospect bar 805. Here, prospects may be filtered by comparing certain prospect attributes to a predefined prospect attribute range so that only prospects falling within the predefined range are included in the tour. More specifically, by using the scroll bar designators for the upper and lower limits, the user can define a range of prospects to include in the search. In the example shown, the user has specified a search range of 50% to 100% IRR, which corresponds with the medium IRR threshold and the high IRR threshold, respectively.

Additionally, the IRR prospects can further be filtered by identifying whether they are “on-net” 815, “safe-net only” 820 and/or there is property contact information available for the identified prospect 825. Thus, for example, with the “on-net only” option 815 being selected, only prospects that are directly connect to the telecommunication infrastructure would be included in the prospect tour results. On-net prospects may thus be serviced directly by the provider without an intermediate provider to provide a connection between the prospect and the telecommunication network. The “safe-net only” option 820, on the other hand allows the user to filter the prospect sites to those that are not directly connected to the infrastructure, but are connected to a third-party that is connected to the infrastructure. For example, in the case of networking infrastructure, it is common for an area to only be serviced by one or more local providers. The local providers may not have infrastructure though the state, region, country, or world. Thus, to provide access to the Internet, for example, the local provider connects to a network operated by another company that provides complete Internet access. In this case, the prospects receiving services from the local providers are “safe-net” prospects. If neither attribute is “on”, then all prospects including those that are neither on-net for safe-net would be included in the search.

Additionally, the user can further filter the prospect tour list to those prospects for which contact information is available. The system can determine such information by querying any of the available databases. Although, the discussion of FIG. 8 is provided in connection to filtering prospects based on IRR data, a similar prospect filter may be provided to the user for filtering prospects based on MRR 710 data. For example, as shown in FIG. 8, there may be options to filter prospects outside a set a range of MRR and potential MRR. Further, there may be additional options to filter prospects outside a set range of metro distance and/or total capital.

Following the selection of prospects for the tour from the computed geographic envelope and based on the selected prospect filter criteria, the intelligent assistant may begin to determine an optimal prospect tour route for visiting the identified prospects. Referring again to FIG. 3, to generate the optimal prospect tour route for visiting the identified prospects, the intelligent assistant begins by computing the drive times and drive distances (i.e. driving route timeline) from and to each one of the identified prospects and begin and/or end locations (operation 330). In other words, the intelligent assistant determines the drive times and drive distances between each origin and destination location, where the origin and destination locations can be the beginning tour location, the ending tour location or the selected prospect locations. In one specific implementation, the drive time and drive distances between different origins and destinations can be obtained by performing an origin-destination cost matrix query.

The driving route timeline for each prospect to be visited on the tour may be used by the intelligent assistant to determine the shortest tour path between the identified prospects and the beginning and ending locations (operation 340). The intelligent assistant may use a Dijkstra Shortest Path method for this purpose. In particular, each origin and destination points (e.g. beginning, ending and prospect locations) in the route may be treated as nodes in a Dijkstra Shortest Path graph and each of the previously determined drive distances and drive times may serve as edges in the graph. The Dijkstra Shortest Path method may use the node and edge information to determine the path with a lowest cost (the shortest path) between a node and every other node in the graph and costs of shortest paths from a single node to a single destination node. In other words, the Dijkstra Shortest Path method returns a graph of all permutations of shortest routes for visiting identified prospects from the beginning location of the tour to the end location.

In order to ensure that the generated tour route maximizes the ability of the user to generate and convert sales or other business opportunities, the intelligent assistant may determine the optimal path and sequence for visiting prospects (operation 350) along the previously determined shortest tour paths. Again, the Dijkstra Shortest Path method may be used for this purpose wherein the determined graph of all permutations of shortest routes is traversed to find an optimal path that allows the user to visit the most valuable prospects within the specified constraints. In particular, the optimal path may be determined from the information determined for each prospect and included in each node, such as the internal rate of return for the prospect, monthly recurring revenue, or the cumulative prospect value or other. In other words, the intelligent assistant may use some of the previously determined prospect parameters to determine the optimal path and sequence for the prospect tour. In particular and as discussed above, the intelligent assistant may use the previously computed and assigned prospect values to rank prospects for the tour. The intelligent assistant may utilize the prospect ranking to determine the optimal sequence in which the prospects should be visited in the prospect route. Furthermore, the intelligent assistant may optimize the tour route by maximizing the total prospect value for the tour and/or ensuring that the cumulative time and distance of the tour does not exceed the available time and drive distance limits set by the user.

To determine the optimal prospect tour route, the intelligent assistant uses the determined optimal path, optimal sequence and the beginning and ending tour locations. In particular, the intelligent assistant performs a route query in appropriate databases using the previously determined information to identify the optimal prospects to visit on the tour. In other words, the optimal prospect tour route generated by the intelligent assistant provides the user with a route from the beginning tour location to the end tour location via optimal prospects.

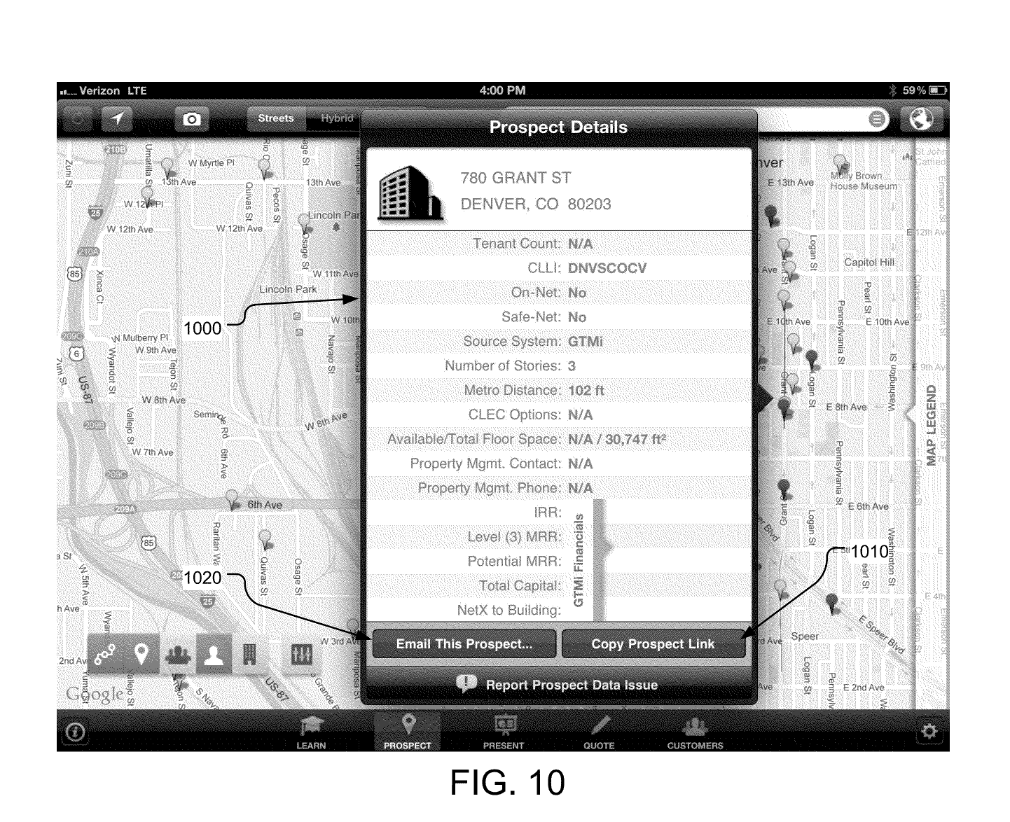

An example of an optimal prospect tour route that was determined based on the inputs provided by the user through the various intelligent assistant interfaces 245 and subject to the method steps discussed above is shown in FIG. 9. More specifically, FIG. 9 illustrates one possible prospect tour route for the selected area of Manhattan, N.Y. While Manhattan has been used here in order to illustrate various aspects of the present disclosure, the concepts discussed herein are not in any way limited to any specific geographic area and may be applied to other areas throughout the United States and the world. In this example and as also discussed with reference to FIG. 5A-5C, the user has defined the time available for the tour of six hours and a drive distance of sixty miles. Thus, within the search GUI the available time slider is set to 6:00 hours and the drive distance slider is set to 60 miles. Further, the user, through the various mechanisms discussed herein, has specified the starting and ending locations for the tour. In particular, as shown in FIG. 5B the user entered both the beginning and end locations as indicated by the tour begin 540a and tour end 540C drop pins. Furthermore, as shown and discussed with reference to FIG. 7, the user has indicated the average drive speed for the tour as being 35 mph, the stop duration for each stop equal to 30 minutes and the maximum number of stops equals three. Thus, based on the information supplied by the user, the intelligent assistant returned a total of three prospects for the tour as indicated by the numbered graphical “stop sign” location pins 930 shown on the map. According to one implementation, each graphical “stop sign” 930 on the map is a hot link to further information about the customer and/or prospect at the given location. So, for example, selection of a graphical “stop sign” 930 for one of the tour points shown on the map may result in a display of a pop-up 910 that provides address information for the selected tour point. The displayed pop-up may also include further information for the selected prospect location or include a mechanism for obtaining such information. In one specific example, the additional information on the prospect location may be obtained by selecting an information icon 920 shown in FIG. 9. In particular, selection of the information icon 920 may initiate a query of an appropriate database, such as for example GTMi database shown in FIG. 2 that returns prospect details, some of which are shown in FIG. 10. In particular, the provided prospect information may include such details as prospect IRR data, MRR data, information if the prospect is on-net, safe-net, among others.

In addition to displaying prospect tour route on a map, the intelligent assistant also provides the user with an option to review the prospect tour in a list format. In one specific example, the list of prospects may be provided in a prospect tour GUI 950 that can be accessed by selecting a prospect tour tab 955 provided by the intelligent assistant. Thus, the prospect tour GUI 950 lists prospects shown along the tour route on the map, with all the prospects 990 being numbered sequentially to indicate the order in which each prospect is to be visited during the tour. In addition, each prospect 990 listed includes a short highlight of information on the prospect, such as a tour timeline 960, address information 965, MRR/IRR information 970 or number of tenants 975 in the prospect building. The format and the type of information provided to the user may be based on a number of output parameters that are either user defined or otherwise predefined within the system. Thus, as shown in the figure, the provided results may be defined to include a tour plan which has set a of prospects that can be visited, the order they can be visited in, the arrival and departure times for all stops, and the drive route/directions for the tour, among other information. Furthermore, the prospect tour GUI 950 may include options for customizing the display of the prospect list by, for example, specifying the total number of prospects that are to be displayed in the GUI, which can be done by using display option button 980 or an option to either display or hide the tour route on the map through the selection of a route show/hide button 985.

As shown in FIG. 9, the prospect tour GUI 950 allows the user to examine prospects included in the tour and/or the tour statically, by selecting components along the tour in any sequence, or the user can play the tour to pre-view the intended visitation sequence dynamically by selecting a route visualization button 995. So, for example, selection of any of the prospects 990 listed in the prospect tour GUI 950 causes a selection of a corresponding tour point on the map to help the user visualize prospect location. Similarly, selecting of any of the tour points 930 on the map causes the corresponding tour point to be highlighted or otherwise marked in the prospect tour GUI 950 to provide the user with additional information on the selected prospect. When the user elects to dynamically pre-view the route a small graphical arrow or a car 940 may be displayed along the tour route to indicate the general direction for the tour.

Additionally, the prospect GUI may include further options for filtering prospects that are to be included in the tour. In particular, for each identified prospect the user may be provided with an option to exclude certain customers or prospects from the prospect tour by selecting a provided prospect exclude icon or button 995. So, for example, if a user recently visited a particular customer, then that customer might be excluded from the prospect tour. The prospect filter parameter that allows the user to exclude certain prospects from a tour may be a boolean predicate that is used for each prospect. Thus, for example if the filter is set to false, the prospect may be excluded from the search. Within the GUI, the user may also be given an option to exclude all of the identified prospects from the tour by selecting the exclude all prospects icon or button 994, as well as the option to include all prospects with the icon 992. When any or all of the identified prospect locations are excluded from the prospect tour as discussed above the user may be provided with an option to create a new tour that skips some or all of the excluded tour points from the initially generated prospect tour. According to one embodiment, the user may be provided with an option to create a new search by being redirected to use the search and/or configuration GUIs as discussed above. In response, to the newly provided prospect criteria, the intelligent assistant may generate and display a new prospect tour route.

Turning to FIG. 10, an example popup window depicting prospect details 1000 is depicted. The prospect details 1000 may have an options for viewing a tenant list that includes all of the known tenants at the location. Selecting the view tenant details option may cause the window to display specific tenant details, such as the tenant name and other relevant information such as the number of employees the tenant has, the size of the tenant's space, the type of location (i.e. corporate headquarters), the monthly recurring revenue for the tenant, the specific type or grouping of industry of businesses such as a vertical market the tenant belongs to, and a contact phone number for the tenant. The tenant details also provide contact lists associated with the tenants, and contact records for each of the contacts. A user may select a contact to create an appointment. The prospect details may also include the prospect address and detailed information about the prospect including the number of tenants located at the prospect, the projected internal rate of return of the prospect, the current and marginal rate of return, the potential marginal rate of return, the total capital costs of extending the technical infrastructure to the prospect, the proximity to technical infrastructure, the square footage, the metro distance, the number of stories, whether the building is On-Net, Off-Net or Safe-Net, and any contact information for the prospect.

The prospect window 1000 may include options that invoke features of other modules. For example, when a prospect's details are displayed, the window 1000 may include a “copy prospect link” option 1010 and/or an “email this prospect link” option 1020. The copy prospect link function 1010 may create a bookmark to the prospect in the bookmarks of the learn module. Selecting the prospect link in the learn module will cause the prospect module to be loaded and, if possible (i.e. either connected to a network, or the map is loaded in cache), show a map with the location of the prospect.

Referring to FIG. 11, an excluded prospect GUI 1100 provides a mechanism that allows a user to further manage prospect previously excluded from the prospect list. For example, the excluded prospect GUI 1100 allows the user to remove previously excluded prospects from the exclusion list by selecting the previously excluded prospect 1115 and thus once again include the prospects in the tour. The excluded prospect GUI 1100 also allows a user to remove all prospects from the exclusion list 1105 or show/hide excluded prospects on the map 1110. Furthermore, the excluded prospect GUI 1100 provides such information as a total number of prospects currently on the exclusion list 1115 or duration the prospect has been on the exclusion list 1120 to help the user to better manage prospects. The prospect exclusion options can be used both in the excluded prospect GUI 1100 or on the generated prospect map by toggling the prospect pin 1150.

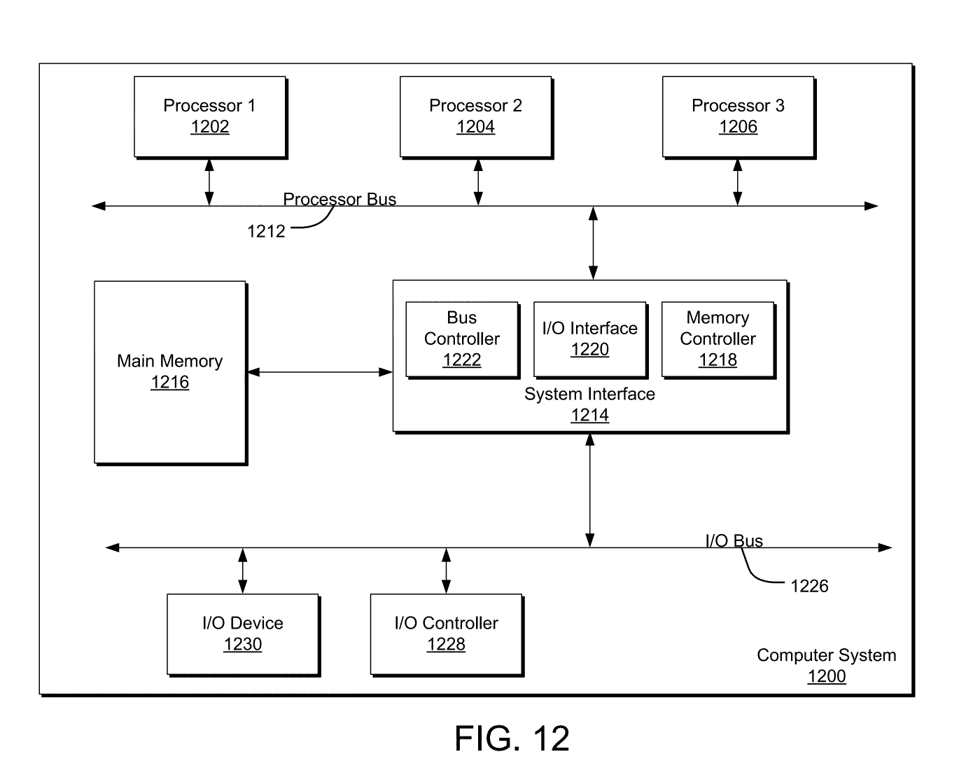

FIG. 12 is a block diagram illustrating an example of a computing device or system which may be used in implementing embodiments of the present disclosure. The computer system 1200 shown includes one or more processors 1202-1206. Processors 1202-1206 may include one or more internal levels of cache (not shown) and a bus controller 1220 or bus interface unit to direct interaction with the processor bus 1212. Processor bus 1212, also known as the host bus or the front side bus, may be used to couple the processors 1202-1206 with the system interface 1214. Processors 1202-1206 may also be purpose built for processing/mixing media data, such as audio or video components of a media stream, such as a digital switch processor. System interface 1214 may be connected to the processor bus 1212 to interface other components of the system 1200 with the processor bus 1212. For example, system interface 1214 may include a memory controller 218 for interfacing a main memory 1216 with the processor bus 1212. The main memory 1216 may include one or more memory cards and a control circuit (not shown), or other forms of removable memory. System interface 1214 may also include an input/output (I/O) interface 1220 to interface one or more I/O bridges or I/O devices with the processor bus 1212. One or more I/O controllers and/or I/O devices may be connected with the I/O bus 1226, such as I/O controller 1228 and I/O device 1230, as illustrated.

I/O device 1230 may also include an input device (not shown), such as an alphanumeric input device, including alphanumeric and other keys for communicating information and/or command selections to the processors 1202-1206. Another type of user input device includes cursor control, such as a mouse, a trackball, or cursor direction keys for communicating direction information and command selections to the processors 1202-1206 and for controlling cursor movement on the display device. In the case of a tablet device, the input may be through a touch screen, voice commands, and/or Bluetooth connected keyboard, among other input mechanisms.

System 1200 may include a dynamic storage device, referred to as main memory 1216, or a random access memory (RAM) or other computer-readable devices coupled to the processor bus 1212 for storing information and instructions to be executed by the processors 1202-1206. Main memory 1216 also may be used for storing temporary variables or other intermediate information during execution of instructions by the processors 1202-1206. System 1200 may include a read only memory (ROM) and/or other static storage device coupled to the processor bus 1212 for storing static information and instructions for the processors 1202-1206. The system set forth in FIG. 12 is but one possible example of a computer system that may employ or be configured in accordance with aspects of the present disclosure.

According to one embodiment, the above techniques and illustrated module functionality and displays may be performed by computer system 1200 in response to processors 1202-1206 executing one or more sequences of one or more instructions contained in main memory 1216. These instructions may be read into main memory 1216 from another machine-readable medium, such as a storage device. Execution of the sequences of instructions contained in main memory 1216 may cause processors 1202-1206 to perform the process steps described herein. In alternative embodiments, circuitry may be used in place of or in combination with the software instructions. Thus, embodiments of the present disclosure may include both hardware and software components.

A machine readable medium includes any mechanism for storing information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 1216. Common forms of machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

We claim:

1. A customer tour optimization system comprising:
a computing device including at least one processor and having at least one local memory, the at least one local memory including a plurality of computer executable instructions for execution on the at least one processor, the instructions configured to cause the at least one processor to:
receive at least one geographic search parameter for a selected geographic area, the at least one geographic search parameter used to determine a geographic boundary for a prospect tour;
receive at least one customer filter parameter, the at least one customer filter parameter is used to select customers from the selected geographic area based on an attribute of the customer;
access a database of customer information associated with the at least one geographic search parameter;
identify at least a first customer based conforming with the at least one geographic search parameter and the at least one customer filter parameter; and
generate the prospect tour to the at least one identified customer based on the received at least one geographic search parameter and the at least one prospect filter parameter, the prospect tour defining a travel route from a starting location and an ending location where the travel route includes a location of the at least one identified customer.

2. The system of claim 1, wherein the computer executable instructions further cause the at least one processor to display the travel route on a map for the generated prospect tour.

3. The system of claim 1, wherein the at least one geographic search parameter includes information on at least one location within the selected geographic area, the at least one location within the selected geographic area being the starting location for the prospect tour.

4. The system of claim 1, wherein the at least one geographic search parameter includes information on a maximum drive distance to be covered during the prospect tour.

5. The system of claim 1, wherein the at least one geographic search parameter includes information on a time available for completing the prospect tour.

6. The system of claim 1, wherein the computer executable instructions further cause the at least one processor to determine the geographic boundary for the prospect tour based on the received at least one geographic search parameter, the geographic boundary defining an area from which to select customers for the prospect tour.

7. The system of claim 3, wherein the computer executable instructions further cause the at least one processor to:
determine at least a second customer for the at least one geographic search criteria and for the at least one customer filter criteria; and
determine a timeline for the prospect tour, the timeline including drive times and drive distances from the starting location to each of the first customer and the second customer and from the first customer to the second customer.

8. The system of claim 7, wherein the computer executable instructions further cause the at least one processor to define the travel route to be the shortest route that encompasses the stating location, the ending location, the first customer and the second customer.

9. The system of claim 8, wherein the computer executable instructions further cause the at least one processor to determine an optimal route for the prospect tour wherein the optimal route is determined based on at least one unique attribute of the first customer and the second customer.

10. The system of claim 9 wherein the at least one unique attribute is based on internal rate of return (IRR) data for each of the first customer and the second customer.

11. The system of claim 9, wherein the at least one customer filter parameter includes at least one threshold value and wherein the at least one unique attribute for each of the first customer and the second customer meets the at least one threshold value.

12. The system of claim 1, wherein the computer executable instructions further cause the at least one processor to determine an optimal sequence for visiting customers on the prospect tour along the travel route wherein the optimal sequence for visiting customers is determined based on a customer ranking, the customer ranking being determined based at least one prospect attribute associated with each customer.

13. The system of claim 6, wherein the computer executable instructions further cause the at least one processor to determine an optimal route for the prospect tour wherein the optimal route is determined based on a total prospect value for the tour, the total prospect value for the tour being equal to a sum of prospect values for each customer.

14. The system of claim 13, wherein the total prospect value is maximized to provide the user with a prospect tour that maximizes user ability to generate and convert sales opportunities.

15. The system of claim 13, wherein each prospect value for each customer is based on at least one prospect attribute, wherein the at least one prospect attribute is mapped to a number representing the prospect value.

16. A method for optimizing customer tour in a selected geographic area, the method comprising:
receiving at least one geographic search parameter for a selected geographic area;
determining a geographic boundary for a customer tour using the at least one geographic search parameter;
receiving at least one prospect filter parameter, the at least one prospect filter used to select customers located within the geographic boundary;
identifying at least a first customer based on the at least one geographic search parameter and the at least one prospect filter parameter; and
determining a customer tour route to the at least one identified customer based on the received at least one geographic search parameter and the at least one prospect filter parameter.
